(19) United States
(12) Patent Application Publication
(10) Pub. No.: US 2021/0024376 A1
(43) Pub. Date: Jan. 28, 2021

(54) INTELLIGENT INDUSTRIAL SEWAGE TREATMENT AIR MACHINE DEVICE

(71) Applicant: Dongguan University of Technology, Dongguan (CN)

(72) Inventors: Jun Tian, Dongguan (CN); Wenfang Li, Dongguan (CN)

(21) Appl. No.: 16/804,591

(22) Filed: Feb. 28, 2020

(30) Foreign Application Priority Data
Jul. 23, 2019 (CN) 201910664134.6

(51) Int. Cl. C02F 1/24; C02F 1/52; C02F 1/00; C02F 1/40

(52) U.S. Cl. CPC C02F 1/24; C02F 1/40; C02F 1/006; C02F 1/5281

(57) ABSTRACT

An intelligent industrial sewage treatment air machine device is provided, including a drug delivering mechanism, a mixing mechanism, a pressurized dissolved air flotation mechanism, a stirring mechanism, and a slag scraping mechanism. The drug delivering mechanism is in communication with the mixing mechanism. The mixing mechanism is in communication with the pressurized dissolved air flotation mechanism through a first water pump. The pressurized dissolved air flotation mechanism is in communication with a second water pump through a water pipe. An air compressor is provided on one side of the second water pump, and in communication with a dissolved air tank through the air pipe. The water outlet of the dissolved air tank is in communication with the pressurized dissolved air flotation mechanism through a water pipe, and the water inlet of the dissolved air tank is in communication with a third water pump through a water pipe.

### CROSS-REFERENCE TO RELATED APPLICATION

This application claims priority to, Chinese Application No. 201910664134.6, filed Jul. 23, 2019. The above-mentioned patent application is incorporated herein by reference in its entirety.

### TECHNICAL FIELD

The present invention relates to sewage treatment devices, and more particularly relates to an air machine device used for sewage treatment in industrial production settings.

### BACKGROUND

With the rapid development of industry and manufacturing, the inevitable amount of waste and wastewater generated during industrial production will greatly increase. Therefore, in order to ensure that the natural environment will not be harmed by the side effects of industrial development, great efforts are required in the development of environmental protection.

At present, the treatment of sewage is polarized by enterprises in the society. Large enterprises are stricter in treating sewage. Generally, a wastewater pool is built to treat a large amount of wastewater generated during production of the enterprise. However, this method is costly and is only suitable for large enterprises. On the one hand, small enterprises cannot afford a high sewage treatment cost, and on the other hand, they directly discharge industrial sewage with the idea that their enterprises produce less sewage.

Accordingly, it is desirable to provide a sewage treatment air machine device with a low cost and a good sewage treatment effect to solve these and other known problems in the conventional art.

### SUMMARY

To achieve the above objectives and overcome the technical defects in the art, embodiments of the present invention provide an intelligent industrial sewage treatment air machine device, including a drug delivering mechanism, a mixing mechanism, a pressurized dissolved air flotation mechanism, a stirring mechanism, and a slag scraping mechanism. The drug delivering mechanism is in communication with the mixing mechanism. The mixing mechanism is in communication with the pressurized dissolved air flotation mechanism through a first water pump. A stirring mechanism is provided on one side of the pressurized dissolved air flotation mechanism. A slag scraping mechanism is provided on the side of the pressurized dissolved air flotation mechanism remote from the stirring mechanism. The pressurized dissolved air flotation mechanism is in communication with a second water pump through a water pipe. An air compressor is provided on one side of the second water pump. The air compressor is in communication with a dissolved air tank through the air pipe. The water outlet of the dissolved air tank is in communication with the pressurized dissolved air flotation mechanism through a water pipe. The water inlet of the dissolved air tank is in communication with a third water pump through a water pipe. The third water pump is in communication with the lower end of the pressurized dissolved air flotation mechanism through a water pipe.

In some embodiments, the drug delivering mechanism includes a first mounting frame. The first mounting frame is mounted with a first storage hopper, an outlet of the first storage hopper is provided with a belt conveyor, an upper end of the belt conveyor is provided with a discharge port provided with a second storage hopper, the second storage hopper is mounted on a second mounting frame, the second mounting frame is located below the front side of the belt conveyor, the discharge port of the second storage hopper is provided with a screw feeder, and the discharge port of the screw feeder is in communication with the mixing mechanism.

In further embodiments, a recovery box is provided below the lower end of the belt conveyor, and the recovery box is located on the lower middle side of the first mounting frame.

In another embodiment, the mixing mechanism includes a drug storage tank. The drug storage tank is in communication with the discharge port of the screw feeder, a first servo motor is fixed in the middle of the upper end of the drug storage tank, a first rotating shaft is fixed to an end of an output shaft of the first servo motor through a coupler, the first rotating shaft is located in the middle of the inside of the drug storage tank, and a stirring blade is fixed to the lower side of the first rotating shaft.

In yet another embodiment, the pressurized dissolved air flotation mechanism includes an air flotation tank, which includes a coagulation reaction chamber, a contact chamber, an air flotation separation chamber, and a clean water chamber from left to right. The upper end of the coagulation reaction chamber is in communication with the drug storage tank through a first water pump, one side of the upper end of the coagulation reaction chamber is in communication with the second water pump through a water pipe, the bottom end of the air flotation tank is in communication with the third water pump through a water pipe, and the third water pump is in communication with the water inlet of the dissolved air tank through a water pipe.

In some embodiments, the stirring mechanism includes a third mounting frame, which is mounted on one side of the upper end of the air flotation tank. A second servo motor is fixed to the third mounting frame, a second rotating shaft is fixed to an end of an output shaft of the second servo motor through a coupler, the second rotating shaft is located inside the coagulation reaction chamber, and a worm gear stirrer is fixed to a lower end of the second rotating shaft.

In further embodiments, the slag scraping mechanism includes a third servo motor, a reducer is fixed at the end of the output shaft of the third servo motor, the third servo motor and the reducer are both fixed on a fourth mounting frame, the fourth mounting frame is fixed to one side of the upper end of the air flotation tank, a third rotating shaft is fixed to the output end of the reducer through a coupler, the third rotating shaft is rotatably connected to the air flotation tank through a bearing seat, both sides of the third rotating shaft are in key connection with a first sprocket, one side of the first sprocket is in transmission connection with a second sprocket through a chain, the second sprocket is in key connection with a fourth rotating shaft, the fourth rotating shaft is rotatably connected to the air flotation tank through a bearing seat, a slag scraping plate is fixedly connected between the two chains, the slag scraping plate is located above the air flotation separation chamber, and a slag collection groove is fixed to the side wall of the upper end of the air flotation separation chamber close to one side of the first sprocket.

In some embodiments, a support frame is fixed in the middle of the rear end of the air flotation tank.

In another embodiment, a staircase is provided between one side of the support frame and the ground.

In further embodiments, a rain shed is mounted at the top of the support frame.

The technical effects and advantages of the embodiments of the present invention are as follows: (1) the drug is delivered into the drug storage tank through a belt conveyor and a screw feeder, the first rotating shaft is then driven to rotate by the first servo motor, the first rotating shaft drives the stirring blade to rotate in the drug storage tank, the stirring blade then fully stirs the drug and water in the drug storage tank, and then the drug is made into a solution, so that the drug is delivered into the air flotation tank to play a role in time and improve the processing efficiency and quality; (2) high-pressure gas is introduced into the dissolved air tank through an air compressor, bubbles are then generated in the dissolved air tank and the bubbles are introduced into the sewage in the air flotation tank to form a number of micro bubbles, the micro bubbles are precipitated from water and become carriers, so that emulsified oil, micro suspended particles, and other pollutants in the sewage adhere to the bubbles and rise to the water surface with the bubbles to form a three-phase mixture of foam gas, water, and particles (oil), and the foam or scum is collected to realize the purpose of separating impurities and purifying sewage with a good treatment effect and a low manufacturing cost; (3) a second servo motor is provided on the upper end of the coagulation reaction chamber, the second servo motor then drives the second rotating shaft to rotate, and the second rotating shaft drives the worm gear stirrer to rotate in the coagulation reaction chamber so that the drug and sewage are in full contact and reaction so as to promote the full mixing of the sewage and drug and achieve the effect of purifying sewage; and (4) the rotating speed of the third servo motor is reduced through a reducer, the third rotating shaft is then driven to rotate, the third rotating shaft then drives the first sprocket to rotate, the first sprocket then drives the chain to rotate around the second sprocket, and the chain then drives the slag scraping plate to move so as to effectively collect the oil slag separated from the upper side of the air flotation separation chamber and push the oil slag into the slag collecting tank, which facilitates centralized processing and automatically removes slag.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1 is a perspective view illustrating one embodiment of an intelligent industrial sewage treatment air machine device according to the present invention.

FIG. 2 is an enlarged perspective view of detail A in FIG. 1.

FIG. 3 is a rear elevation view of the device of FIG. 1.

FIG. 4 is a perspective view of a mixing mechanism used with the device of FIG. 1.

FIG. 5 is a perspective view of a pressurized dissolved air flotation mechanism and a stirring mechanism used with the device of FIG. 1.

FIG. 6 is a perspective view of a slag scraping mechanism used with the device of FIG. 1.

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to the accompanying drawing and specific implementations.

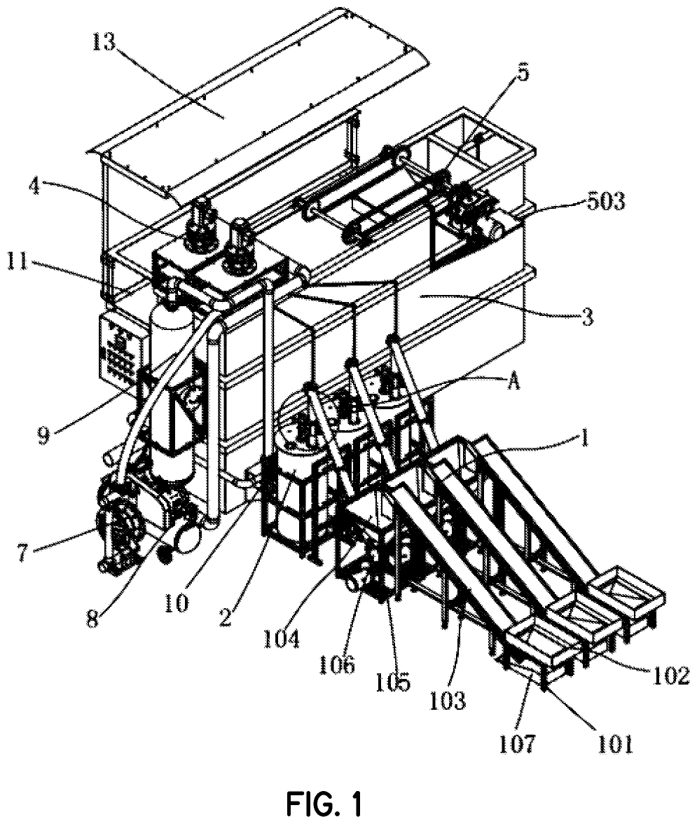

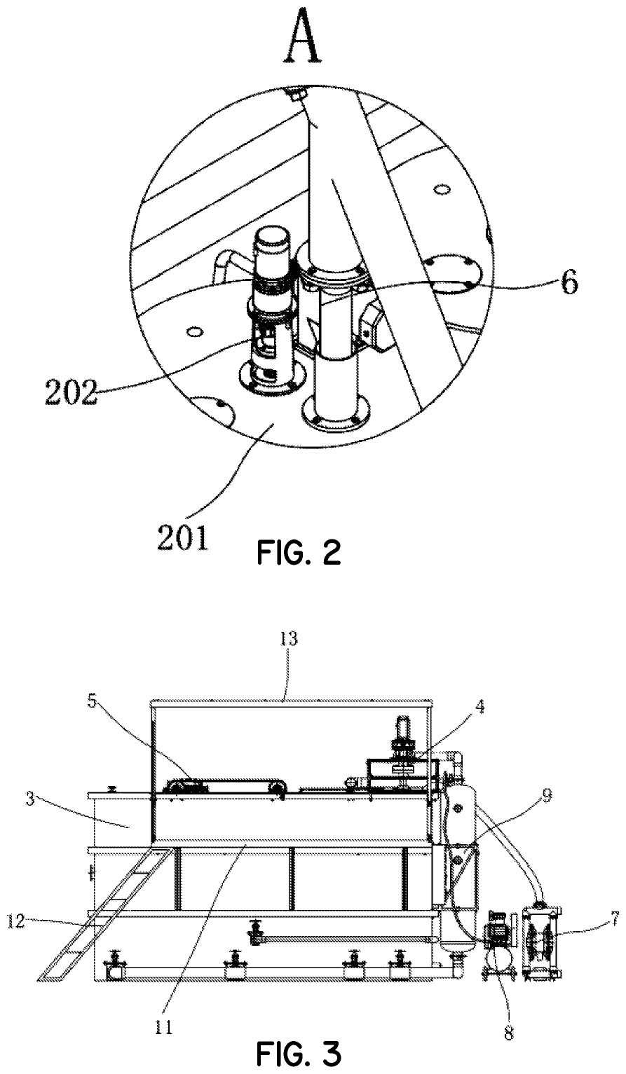

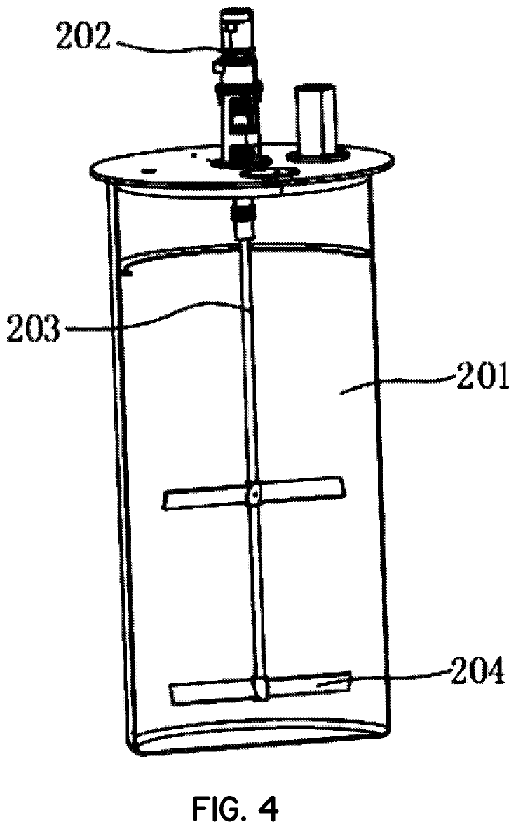

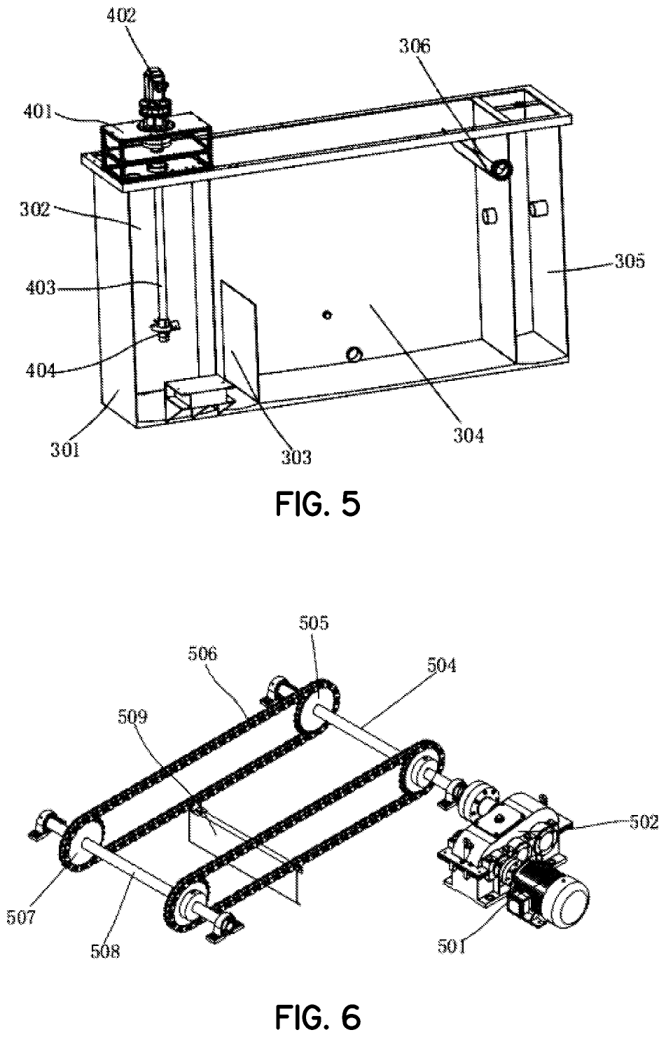

According to one embodiment, an intelligent industrial sewage treatment air machine device is provided as shown in FIGS. 1-6, including a drug delivering mechanism 1, a mixing mechanism 2, a pressurized dissolved air flotation mechanism 3, a stirring mechanism 4, and a slag scraping mechanism 5. The drug delivering mechanism 1 is in communication with the mixing mechanism 2, the mixing mechanism 2 is in communication with the pressurized dissolved air flotation mechanism 3 through a first water pump 6, a stirring mechanism 4 is provided on one side of the pressurized dissolved air flotation mechanism 3, a slag scraping mechanism 5 is provided on the side of the pressurized dissolved air flotation mechanism 3 remote from the stirring mechanism 4, the pressurized dissolved air flotation mechanism 3 is in communication with a second water pump 7 through a water pipe, an air compressor 8 is provided on one side of the second water pump 7, the air compressor 8 is in communication with a dissolved air tank 9 through the air pipe, the water outlet of the dissolved air tank 9 is in communication with the pressurized dissolved air flotation mechanism 3 through a water pipe, the water inlet of the dissolved air tank 9 is in communication with a third water pump 10 through a water pipe, and the third water pump 10 is in communication with the lower end of the pressurized dissolved air flotation mechanism 3 through a water pipe.

Preferably, the drug delivering mechanism 1 includes a first mounting frame 101, the first mounting frame 101 is mounted with a first storage hopper 102, an outlet of the first storage hopper 102 is provided with a belt conveyor 103, an upper end of the belt conveyor 103 is provided with a discharge port provided with a second storage hopper 104, the second storage hopper 104 is mounted on a second mounting frame 105, the second mounting frame 105 is located below the front side of the belt conveyor 103, the discharge port of the second storage hopper 104 is provided with a screw feeder 106, and the discharge port of the screw feeder 106 is in communication with the mixing mechanism 2.

By adopting the above arrangement, drug is delivered from a low place to a high place. Since the second storage hopper 104 of the screw feeder 106 is located in a high place, and the drug has certain damage to human skin, the belt conveyor 103 is used to transfer the materials from a lower place into the second storage hopper 104 of the screw feeder 106 to prevent damage to skin of workers and improve safety.

Preferably, a recovery box 107 is provided below the lower end of the belt conveyor 103, and the recovery box 107 is located on the lower middle side of the first mounting frame 101.

By adopting the above arrangement, the setting of the recovery box 107 facilitates the collection of drug that slides down from the lower end of the belt conveyor 103 and avoids waste.

Preferably, the mixing mechanism 2 includes a drug storage tank 201, the drug storage tank 201 is in communication with the discharge port of the screw feeder 106, a first servo motor 202 is fixed in the middle of the upper end of the drug storage tank 201, a first rotating shaft 203 is fixed to an end of an output shaft of the first servo motor 202 through a coupler, the first rotating shaft 203 is located in the middle of the inside of the drug storage tank 201, and a stirring blade 204 is fixed to the lower side of the first rotating shaft 203.

By adopting the above arrangement, the stirring blade 204 then fully stirs the drug and water in the drug storage tank 201, and then the drug is made into a solution, so that the drug is delivered into the air flotation tank 301 to play a role in time and improve the processing efficiency and quality.

Preferably, the pressurized dissolved air flotation mechanism 3 includes an air flotation tank 301, the air flotation tank 301 comprises a coagulation reaction chamber 302, a contact chamber 303, an air flotation separation chamber 304, and a clean water chamber 305 from left to right, the upper end of the coagulation reaction chamber 302 is in communication with the drug storage tank 201 through a first water pump 6, one side of the upper end of the coagulation reaction chamber 302 is in communication with the second water pump 7 through a water pipe, the bottom end of the air flotation tank 301 is in communication with the third water pump 10 through a water pipe, and the third water pump 10 is in communication with the water inlet of the dissolved air tank 9 through a water pipe.

By adopting the above arrangement, a number of micro bubbles are formed in the sewage in the air flotation tank 301, the micro bubbles are precipitated from water and become carriers, so that emulsified oil, micro suspended particles, and other pollutants in the sewage adhere to the bubbles and rise to the water surface with the bubbles to form a three-phase mixture of foam gas, water, and particles (oil), and the foam or scum is collected to realize the purpose of separating impurities and purifying sewage with a good treatment effect and a low manufacturing cost.

Preferably, the stirring mechanism 4 includes a third mounting frame 401, the third mounting frame 401 is mounted on one side of the upper end of the air flotation tank 301, a second servo motor 402 is fixed to the third mounting frame 401, a second rotating shaft 403 is fixed to an end of an output shaft of the second servo motor 402 through a coupler, the second rotating shaft 403 is located inside the coagulation reaction chamber 302, and a worm gear stirrer 404 is fixed to a lower end of the second rotating shaft 403.

By adopting the above arrangement, the worm gear stirrer 404 rotates in the coagulation reaction chamber 302 so that the drug and sewage are in full contact and reaction so as to promote the full mixing of the sewage and drug and achieve the effect of purifying sewage.

Preferably, the slag scraping mechanism 5 includes a third servo motor 501, a reducer 502 is fixed at the end of the output shaft of the third servo motor 501, the third servo motor 501 and the reducer 502 are both fixed on a fourth mounting frame 503, the fourth mounting frame 503 is fixed to one side of the upper end of the air flotation tank 301, a third rotating shaft 504 is fixed to the output end of the reducer 502 through a coupler, the third rotating shaft 504 is rotatably connected to the air flotation tank 301 through a bearing seat, both sides of the third rotating shaft 504 are in key connection with a first sprocket 505, one side of the first sprocket 505 is in transmission connection with a second sprocket 507 through a chain 506, the second sprocket 507 is in key connection with a fourth rotating shaft 508, the fourth rotating shaft 508 is rotatably connected to the air flotation tank 301 through a bearing seat, a slag scraping plate 509 is fixedly connected between the two chains 506, the slag scraping plate 509 is located above the air flotation separation chamber 304, and a slag collection groove 510 is fixed to the side wall of the upper end of the air flotation separation chamber 304 close to one side of the first sprocket 505.

By adopting the above arrangement, the chain 506 then drives the slag scraping plate 509 to move so as to effectively collect the oil slag separated from the upper side of the air flotation separation chamber 304 and push the oil slag into the slag collecting tank 510, which facilitates centralized processing and automatically removes slag.

Preferably, a support frame 11 is fixed in the middle of the rear end of the air flotation tank 301.

By adopting the above arrangement, it is convenient for a worker to stand on the support frame 11 to observe the sewage treatment status in the air flotation tank 301.

Preferably, a staircase 12 is provided between one side of the support frame 11 and the ground.

By adopting the above arrangement, the staircase 12 is convenient for a worker to climb from the ground to the support frame 11.

Preferably, a rain shed 13 is mounted at the top of the support frame 11.

By adopting the above arrangement, the setting of the rain shed 13 plays a role of blocking rain and prevents rainwater from rushing to workers when it rains.

Having described the structural arrangement of this embodiment of the device, several calculation steps may be performed as follows.

### 1. The Width of the Air Flotation Tank is Determined

The width of the advection air flotation tank is the width of the air flotation chamber, and it is also the width of the coagulation reaction chamber, the contact chamber, the slag collecting tank and the clean water chamber. The corresponding tank width B can be calculated from the surface load of the air flotation separation chamber, the sewage treatment volume and the reflux ratio:

B===1m

Where B is the width m of the tank;

Q is the sewage treatment capacity m³/h;

R is the reflux ratio;

The surface load is taken as 8 m³/(m².h) (generally is taken as m³/(m².h) between 7.2 and 10.8).

### 2. The Length of the Air Flotation Separation Chamber is Calculated

The length of the air flotation separation chamber can be calculated based on the determined width of the air flotation tank and the surface load.

=

Where the length of the air flotation separation chamber is m;

Q is the sewage treatment capacity m³/h;

R is the reflux ratio;

The surface load is taken as 8 m³/(m².h) (generally is taken as m³/(m².h) between 7.2 and 10.8).

B is the width m of the tank.

### 3. The Depth of the Water Layer in the Air Flotation Separation Chamber is Determined and Checked

Generally, the depth of the water layer is between 1.5 and 2.5 m. This design initially determines that the depth of the water layer is 2.4 m. Therefore, it can be checked whether the horizontal flow velocity and residence time of the water stream in the air flotation separation chamber are within a reasonable range:

=m³

Where

The horizontal flow velocity of the water stream in the air flotation separation chamber is m/s (the reasonable range is m/s);

R is the reflux ratio;

Q is the sewage treatment capacity m³/s;

B is the width m of the tank;

the depth of the water layer in the air flotation separation chamber.

=1080 s

Where

The residence time of sewage in the air flotation separation chamber is s (the reasonable range is 900˜3600 s);

B is the width m of the tank;

the depth of the water layer in the air flotation separation chamber.

The length of air flotation separation chamber is m;

Q is the sewage treatment capacity m³/s;

R is the reflux ratio.

After calculation, it is finally obtained that the horizontal flow velocity of the water stream in the air flotation separation chamber=m³ and the residence time=1080 s, which are both within a reasonable range, and the depth of the water layer of the air flotation separation chamber can be determined to be 2.4 m.

### 4. The Length of the Coagulation Reaction Chamber is Calculated

By determining the residence time of the coagulation reaction chamber, the length of the coagulation reaction chamber can be calculated:

=

Where the length of the coagulation reaction chamber is m;

Q is the sewage treatment capacity m³/s;

The residence time of the coagulation reaction chamber is taken as 400 s (generally the range is 300˜900 s);

B is the width m of the tank;

the depth of the water layer in the air flotation separation chamber.

### 5. The Contact Chamber is Calculated

(1) The length of the contact chamber is calculated.

The length of the contact chamber can be calculated from the known width B of the air flotation tank and the surface load of the contact chamber:

=

Where the length of the contact chamber is m;

Q is the sewage treatment capacity m³/s;

R is the reflux ratio;

B is the width m of the tank;

The surface load of the contact chamber is taken as 50 m³/(m².h).

(2) The height of the contact chamber partition is calculated.

The height of the contact chamber partition is determined by the residence time of the contact chamber, so the height of the contact chamber partition can be calculated by determining the residence time of the contact chamber:

=

Where the height of the contact chamber partition is m;

The residence time of the contact chamber is taken as 100 s (generally the range is 60 to 120 s);

Q is the sewage treatment capacity m³/s;

R is the reflux ratio;

B is the width m of the tank;

The length of the contact chamber is m.

### 6. The Length of the Clear Water Chamber is Calculated

The length of the air flotation separation chamber, the length of the contact chamber, and the length of the coagulation reaction chamber are known, and the length/width of the air flotation tank is initially determined to be 5, that is, the total length L=5 (B+2 s), where s is the wall thickness, which is taken as 10 mm=0.01 m.

The length of the clear water chamber=L—5 s=5.02-0.48-0.93-3-0.05=0.56 m.

### 1. The Diameter of the Dissolved air Tank is Determined

According to the relevant regulations of GB/T9019 Nominal Diameter of Pressure Vessels and the amount of sewage treatment, combined with the following table, the diameter of the dissolved air tank is determined to be 500 mm, which is 0.5 m.

| | Flow | Pressure | Diameter of the | Diameter of the |
|---|---|---|---|---|
| Diameter | range | range | water inlet | water outlet |
| of the tank | (MPa) | (MPa) | (MPa) | (MPa) |
| 200 | 3-6 | 0.2-0.5 | 40 | 50 |
| 300 | 7-12 | 0.2-0.5 | 70 | 80 |
| 400 | 13-19 | 0.2-0.5 | 80 | 100 |
| 500 | 20-30 | 0.2-0.5 | 100 | 125 |
| 600 | 31-42 | 0.2-0.5 | 125 | 150 |

### 2. The Height of the Dissolved Air Tank is Calculated

The height of the dissolved air tank consists of four parts, which include the height of the water and gas distribution space, the height of the filling layer, the height of the buffer zone, and the height of the water layer at the bottom of the tank, as shown in the figure above. The total height of the dissolved air tank is:

H=2 ++++

Where H is the total height m of the dissolved air tank;

The height of the head of the top of the tank is m;

The height of the water and gas distribution space is 0.2 (generally 0.2˜0.4 m);

The height of the filling layer is 1 m (generally 1˜1.5 m);

The height of the buffer zone is 0.2 (generally 0.2˜0.5 m);

The height of the water layer at the bottom of the tank is 0.8 (0.8˜1.2 m);

Among them, an elliptical head with the inner diameter as the nominal diameter is mostly used at present. According to JB1154-73, the relationship between the head height and the nominal diameter is as follows:

=+=125+40=165 mm=0.165 m

Where the head height is m;

The wall thickness is m;

Therefore, the total height of the dissolved air tank is H=2++++=2 m.

### 3. The Diameters of the Water Inlet and the Water Outlet of the Dissolved Air Tank are Determined

According to Table 4.1, the design initially determined that the diameter of the water inlet of the dissolved air tank is 100 mm, and the diameter of the water outlet is 125 mm.

### 4.2.3 Selection of an Air Compressor

### 1. Determination and Verification of the Reflux Ratio (R)

The so-called reflux ratio refers to the ratio of the volume of the part where the treated sewage flows back to the volume of the sewage prior to the treatment. The reflux ratio is generally selected between 0.1 and 0.5. The larger the reflux ratio is, the more the air supply is, which is beneficial to the air flotation separation. At the same time, the investment cost of the dissolved air tank and the air flotation tank also increases. Therefore, it is generally recommended that the reflux ratio be between 0.2 and 0.3.

The design initially selects the reflux ratio of 0.2. In order to verify the rationality of the selected reflux ratio, we use the gas-solid ratio for verification. The normal range of the gas-solid ratio is between 0.01 and 0.04. When the calculated gas-solid ratio is outside the normal range, the reflux ratio is re-selected for calculation if necessary. The so-called gas-solid ratio refers to the ratio of the amount of gas provided in the air flotation tank to the content of oil or the content of suspended solids in the treated sewage. The calculation process is as follows:

$$= ( f - ) \\ = ( 0.95 \times 0.3 - 0.1 )$$

0.038

Where R is the reflux ratio,

Conversion coefficient,

H is the Henry coefficient,

f is the dissolved air saturation efficiency,

Pressure of the dissolved air tank,

Pressure at the outlet of the releaser of the air flotation tank,

C is the content of oil or suspended solids in sewage,

Finally, the gas-solid ratio is 0.038 by calculation, which is within a reasonable range, so the selected reflux ratio R=0.2 is reasonable.

### 2. Calculation of Air Consumption

According to the fact that the dissolved air water is completely saturated and has abundance to some extent, the air consumption is

=Φ=1.20.41 Nm³/h;

Where the air supply is Nm³/h;

Φ is the abundant coefficient, the value of which is 1.2 (generally 1.1˜1.2);

Pressure of the dissolved air tank,

R is the reflux ratio;

Q is the sewage treatment capacity m³/s;

Conversion coefficient, refer to Table 1;

H is the Henry coefficient,

According to the ideal air state equation P1V1/T1=P2V2/T2, it is concluded that:

=0.0025

According to the air supply amount =0.0025

and the operating pressure of 0.3=0.5 (0.2 is the pressure margin), the FG07 three-phase air compressor is selected.

A method of operating the device in accordance with embodiments of the invention is now described: drug is firstly added into the first storage hopper 102, and then the drug is delivered into the drug storage tank 201 through the belt conveyor 103 and the screw feeder 106, the drug and water added in the drug storage tank 201 in advance are mixed, the first rotating shaft 203 is then driven to rotate by the first servo motor 202, the first rotating shaft 203 drives the stirring blade 204 to rotate in the drug storage tank 201, the stirring blade 204 fully stirs the drug and water in the drug storage tank 201, the drug is then made into a solution, the first water pump 6 then delivers the prepared drug solution to the coagulation reaction chamber 302 in the air flotation tank 301, and the second water pump 7 also delivers sewage to the coagulation reaction chamber 302.

A second servo motor 402 is provided on the upper end of the coagulation reaction chamber 302, the second servo motor 402 then drives the second rotating shaft 403 to rotate, and the second rotating shaft 403 drives the worm gear stirrer 404 to rotate in the coagulation reaction chamber 302 so that the drug solution and sewage are in full contact and reaction so as to promote the full mixing of the sewage and drug and achieve the effect of purifying sewage.

The third water pump 10 delivers the sewage flowing back from the air flotation tank 301 to the dissolved air tank 9. High-pressure gas is introduced into the dissolved air tank 9 through an air compressor 8, bubbles are then generated after the high-pressure gas is mixed with the sewage in the dissolved air tank 9, the bubbles are introduced into the sewage in the air flotation tank 301 by the dissolved air tank 9 to form a number of micro bubbles, the micro bubbles are precipitated from water and become carriers, so that emulsified oil, micro suspended particles, and other pollutants in the sewage adhere to the bubbles and rise to the water surface with the bubbles to form a three-phase mixture of foam gas, water, and particles (oil), and the foam or scum is collected to realize the purpose of separating impurities and purifying sewage.

The rotating speed of the third servo motor 501 is reduced through a reducer 502, the third rotating shaft 504 is then driven to rotate, the third rotating shaft 504 then drives the first sprocket 505 to rotate, the first sprocket 505 then drives the chain 506 to rotate around the second sprocket 507, and the chain 506 then drives the slag scraping plate 509 to move forward and backward, so as to effectively collect the oil slag separated from the upper side of the air flotation separation chamber 304 and push the oil slag into the slag collecting tank 510, which facilitates centralized processing and automatically removes slag. Then the treated water enters the clean water chamber 305, and is finally discharged through a drain pipe on the side of the clean water chamber 305, and the entire process is completed.

The embodiments described above are only descriptions of preferred embodiments of the present invention, and are not intended to limit the scope of the present invention. Various variations and modifications can be made to the technical solution of the present invention by those of ordinary skills in the art, without departing from the design of the present invention. The variations and modifications should all fall within the claimed scope defined by the claims of the present invention.

### REFERENCE LIST

1. a drug delivering mechanism
101. a first mounting frame
102. a storage hopper
103. a belt conveyor
104. a second storage hopper
105. a second mounting frame
106. a screw feeder
107. a recovery box
2. a mixing mechanism
201. a drug storage tank
202. a first servo motor
203. a first rotating shaft
204. a stirring blade
3. a pressurized dissolved air flotation mechanism
301. an air flotation tank
302. a coagulation reaction chamber
303. a contact chamber
304. an air flotation separation chamber
305. a clean water chamber
306. a slag collecting tank
4. a stirring mechanism
401. a third mounting frame
402. a second servo motor
403. a second rotating shaft
404. a worm gear stirrer
5. a slag scraping mechanism
501. a third servo motor
502. a reducer
503. a fourth mounting frame
504. a third rotating shaft
505. a first sprocket
506. a chain
507. a second sprocket
508. a fourth rotating shaft
509. a slag scraping plate
510. a slag collecting tank
6. a first water pump
7. a second water pump
8. an air compressor
9. a dissolved air tank
10. a third water pump
11. a support frame
12. a staircase
13. a rain shed

What is claimed is:

1. An intelligent industrial sewage treatment air machine device, comprising:
a drug delivering mechanism,
a mixing mechanism,
a pressurized dissolved air flotation mechanism,
a stirring mechanism, and
a slag scraping mechanism,
wherein the drug delivering mechanism is in communication with the mixing mechanism, the mixing mechanism is in communication with the pressurized dissolved air flotation mechanism through a first water pump, a stirring mechanism is provided on one side of the pressurized dissolved air flotation mechanism, a slag scraping mechanism is provided on the side of the pressurized dissolved air flotation mechanism remote from the stirring mechanism, the pressurized dissolved air flotation mechanism is in communication with a second water pump through a water pipe, an air compressor is provided on one side of the second water pump, the air compressor is in communication with a dissolved air tank through an air pipe, a water outlet of the dissolved air tank is in communication with the pressurized dissolved air flotation mechanism through a water pipe, a water inlet of the dissolved air tank is in communication with a third water pump through a water pipe, and the third water pump is in communication with a lower end of the pressurized dissolved air flotation mechanism through a water pipe.

2. The device of claim 1, wherein the drug delivering mechanism comprises:
a first mounting frame, which is mounted with a first storage hopper, an outlet of the first storage hopper is provided with a belt conveyor, an upper end of the belt conveyor is provided with a discharge port provided with a second storage hopper, the second storage hopper is mounted on a second mounting frame, the second mounting frame is located below the front side of the belt conveyor, the discharge port of the second storage hopper is provided with a screw feeder, and the discharge port of the screw feeder is in communication with the mixing mechanism.

3. The device of claim 2, further comprising:
a recovery box provided below a lower end of the belt conveyor, wherein the recovery box is located on the lower middle side of the first mounting frame.

4. The device of claim 2, wherein the mixing mechanism comprises:
a drug storage tank, which is in communication with the discharge port of the screw feeder, a first servo motor is fixed in the middle of the upper end of the drug storage tank, a first rotating shaft is fixed to an end of an output shaft of the first servo motor through a coupler, the first rotating shaft is located in the middle of the inside of the drug storage tank, and a stirring blade is fixed to the lower side of the first rotating shaft.

5. The device of claim 4, wherein the pressurized dissolved air flotation mechanism comprises:
an air flotation tank, which includes a coagulation reaction chamber, a contact chamber, an air flotation separation chamber, and a clean water chamber from left to right,
wherein the upper end of the coagulation reaction chamber is in communication with the drug storage tank through a first water pump, one side of the upper end of the coagulation reaction chamber is in communication with the second water pump through a water pipe, a bottom end of the air flotation tank is in communication with the third water pump through a water pipe, and the third water pump is in communication with a water inlet of the dissolved air tank through a water pipe.

6. The device of claim 5, wherein the stirring mechanism comprises:
a third mounting frame, which is mounted on one side of the upper end of the air flotation tank, a second servo motor is fixed to the third mounting frame, a second rotating shaft is fixed to an end of an output shaft of the second servo motor through a coupler, the second rotating shaft is located inside the coagulation reaction chamber, and a worm gear stirrer s fixed to a lower end of the second rotating shaft.

7. The device of claim 5, wherein the slag scraping mechanism comprises:
a third servo motor, and
a reducer fixed at the end of the output shaft of the third servo motor, wherein the third servo motor and the reducer are both fixed on a fourth mounting frame, the fourth mounting frame is fixed to one side of the upper end of the air flotation tank, a third rotating shaft is fixed to an output end of the reducer through a coupler, the third rotating shaft is rotatably connected to the air flotation tank through a bearing seat, both sides of the third rotating shaft are in key connection with a first sprocket, one side of the first sprocket is in transmission connection with a second sprocket through a chain, the second sprocket is in key connection with a fourth rotating shaft, the fourth rotating shaft is rotatably connected to the air flotation tank through a bearing seat, a slag scraping plate is fixedly connected between the two chains, the slag scraping plate is located above an air flotation separation chamber, and a slag collection groove is fixed to a side wall of the upper end of the air flotation separation chamber close to one side of the first sprocket.

8. The device of claim 5, wherein a support frame is fixed in the middle of a rear end of the air flotation tank.

9. The device of claim 8, further comprising:
a staircase provided between one side of the support frame and the ground.

10. The device of claim 8, further comprising:
a rain shed mounted at the top of the support frame.
